(19) United States
(12) Patent Application Publication
(10) Pub. No.: US 2025/0211372 A1
(43) Pub. Date: Jun. 26, 2025

(54) METHOD FOR SELECTING DOWNLINK MCS IN 5G NR SYSTEM

(71) Applicant: EUCAST CO., LTD., Seongnam-si (KR)

(72) Inventor: Dong Kwan LEE, Seongnam-si (KR)

(21) Appl. No.: 18/979,909

(22) Filed: Dec. 13, 2024

(30) Foreign Application Priority Data
Dec. 21, 2023 (KR) 10-2023-0188130
Mar. 28, 2024 (KR) 10-2024-0042600

(51) Int. Cl. H04L 1/1867; H04B 7/06; H04L 5/00

(52) U.S. Cl. CPC H04L 1/1896; H04B 7/0632; H04L 5/0055

(57) ABSTRACT

The present invention relates to a method for selecting a downlink modulation and coding scheme (MCS) in a 5G NR system, which may include transmitting data based on an MCS determined for the terminal, receiving hybrid automatic repeat request (HARQ) feedback indicating whether the transmitted data was successfully received, and determining an MCS to be used for transmitting data to the terminal (hereinafter referred to as the transmission MCS) based on the received HARQ feedback.

### CROSS REFERENCE TO RELATED APPLICATION

The present application claims priority to Korean Patent Application Nos. 10-2023-0188130, filed Dec. 21, 2023 and 10-2024-0042600 filed Mar. 28, 2024, the entire contents of which is incorporated herein for all purposes by this reference.

### FIELD

The present invention relates to a method for selecting a down modulation and coding scheme (MCS) in a 5^{th} Generation New Radio (5G NR) system.

### BACKGROUND

In a mobile communication system such as a 5G NR system, the terminal receives a downlink signal from the base station (gNB) to assess the quality of the data channel and reports the result to the base station as a Channel Quality Indicator (CQI). Based on the reported CQI, the base station (gNB) selects an MCS optimized for the downlink channel that each terminal is experiencing and transmits data to each terminal, thereby optimizing the overall data transmission rate from the base station.

However, for multiple terminals with low mobility, the channel quality remains nearly unchanged, and the CQI reported by the terminals also varies very little. In particular, when many low-mobility terminals are transmitting low-speed data, a significant amount of uplink resources is used for CQI reporting, leading to resource waste and a reduction in uplink throughput.

### SUMMARY

The embodiments of the present invention propose a method for assigning an appropriate MCS to the terminal without using CQI, to minimize uplink resource waste caused by CQI.

A base station of a 5^{th} generation new radio (5G NR) system according to an embodiment may include at least one processor configured to transmit data based on a determined modulation and coding scheme (MCS) for a terminal, receive hybrid automatic repeat request (HARQ) feedback indicating whether the transmitted data was successfully received and determine a transmission MCS being an MCS to be used for transmitting data to the terminal based on the received HARQ feedback.

The at least one processor may be further configured to set a first parameter to a first value, a second parameter to a second value, and a third parameter to a different third value for each MCS, determine the transmission MCS for the initial data transmission to the terminal, update the first parameter based on the HARQ feedback and the second and third parameters, determine whether to increase or decrease the transmission MCS by one level or maintain the transmission MCS based on the updated first parameter.

When the transmission MCS is increased by one level, the at least one processor may be further configured to determine whether a transmission mode is single input multiple output (SIMO) mode or multiple input multiple output (MIMO) mode, set, based on the transmission mode being MIMO mode, a backoff time to zero, change, based on the transmission mode being SIMO mode, the transmission mode to MIMO mode and redetermine the transmission MCS based on a predetermined conversion table when the transmission mode have been in the SIMO mode over the backoff time and the transmission MCS is greater than or equal to a predetermined fourth parameter.

When the transmission MCS is decreased by one level, the at least one processor may be further configured to determine whether the transmission mode is SIMO mode or MIMO mode, and based on the transmission mode being MIMO mode, change the transmission mode to SIMO mode and redetermine the transmission MCS based on a predetermined conversion table when the backoff time is not zero or the transmission MCS is less than or equal to a predetermined fifth parameter and set, based on the back off time being zero, the backoff time to a predetermined minimum backoff time and increase, based on the back off time being not zero, the backoff time to twice the current value.

The at least one processor may be further configured to update, based on the HARQ feedback indicating successful data reception (ACK), the first parameter by subtracting the second parameter from the first parameter and update, based on the HARQ feedback indicating unsuccessful data reception (NACK), the first parameter by adding to the first parameter the value obtained by multiplying the third parameter corresponding to the current transmission MCS by the second parameter.

The first value is 50, the second value is 6, and the at least one processor may be further configured to increase the transmission MCS by one level and reset the first parameter to the first value based on the updated first parameter being less than 0, decrease the transmission MCS by one level, reset the first parameter to the second value and set the second parameter to a fourth value smaller than the second value based on the updated first parameter being greater than 100 and maintain the transmission MCS based on the updated first parameter being greater than or equal to 0 and less than or equal to 100.

The at least one processor may be further configured to upon receiving a channel quality indicator (CQI) from the terminal, determine the transmission MCS based on the CQI, reset the first parameter to the first value and set the second parameter to a fifth value smaller than the second value and greater than the fourth value.

The at least one processor may be further configured to, only upon receiving the channel quality indicator (CQI) for the first time from the terminal, determine the transmission MCS based on the CQI received for the first time, reset the first parameter to the first value and set the second parameter to the fifth value smaller than the second value and greater than the fourth value.

The fourth value may be 1 and the fifth value may be 4.

The at least one processor may be further configured to set the backoff time to a maximum backoff time based on the value obtained by increasing the backoff time to twice the current value being greater than a predetermined maximum backoff time.

A method for determining a downlink modulation and coding scheme (MCS) of a base station according to an embodiment may include transmitting data based on a determined modulation and coding scheme (MCS) for the terminal, receiving hybrid automatic repeat request (HARQ) feedback indicating whether the transmitted data was successfully received and determining a transmission MCS being an MCS to be used for transmitting data to the terminal based on the received HARQ feedback.

The determining of the transmission MCS may include setting a first parameter to a first value, a second parameter to a second value, and a third parameter to a different third value for each MCS, determining the transmission MCS for the initial data transmission to the terminal, updating the first parameter based on the HARQ feedback and the second and third parameters and determining whether to increase or decrease the transmission MCS by one level or maintain the transmission MCS based on the updated first parameter.

The determining whether to increase or decrease the transmission MCS by one level or maintain the transmission MCS based on the updated first parameter comprises, when the transmission MCS is increased by one level, determining whether a transmission mode is single input multiple output (SIMO) mode or multiple input multiple output (MIMO) mode, setting, based on the transmission mode being MIMO mode, a backoff time to zero, changing, based on the transmission mode being SIMO mode, the transmission mode to MIMO mode and redetermining the transmission MCS based on a predetermined conversion table when the transmission mode have been in the SIMO mode over the backoff time and the transmission MCS is greater than or equal to a predetermined fourth parameter.

The determining whether to increase or decrease the transmission MCS by one level or maintain the transmission MCS based on the updated first parameter further comprises, when the transmission MCS is decreased by one level, determining, whether the transmission mode is SIMO mode or MIMO mode, based on the transmission mode being MIMO mode, changing the transmission mode to SIMO mode and redetermining the transmission MCS based on a predetermined conversion table when the backoff time is not zero or the transmission MCS is less than or equal to a predetermined fifth parameter and setting, based on the back off time being zero, the backoff time to a predetermined minimum backoff time and increasing, based on the back off time being not zero, the backoff time to twice the current value.

The updating of the first parameter based on the HARQ feedback and the second and third parameters comprises updating, based on the HARQ feedback indicating successful data reception (ACK), the first parameter by subtracting the second parameter from the first parameter and updating, based on the HARQ feedback indicating unsuccessful data reception (NACK), the first parameter by adding the value obtained by multiplying the third parameter corresponding to the current transmission MCS by the second parameter.

The first value may be 50, the second value may be 6 and the determining of whether to increase or decrease the transmission MCS by one level or maintain the transmission MCS based on the updated first parameter may comprise increasing the transmission MCS by one level and reset the first parameter to the first value based on the updated first parameter being less than 0, decreasing the transmission MCS by one level, reset the first parameter to the second value and set the second parameter to a fourth value smaller than the second value based on the updated first parameter being greater than 100 and maintaining the transmission MCS based on the updated first parameter being greater than or equal to 0 and less than or equal to 100.

The method may further include receiving a channel quality indicator (CQI) from the terminal and determining the transmission MCS based on the CQI, resetting the first parameter to the first value, and setting the second parameter to a fifth value less than the second value and greater than the fourth value.

The method may further include, when CQI is received for the first time from the terminal, determining the transmission MCS based on the CQI received for the first time, resetting the first parameter to the first value and setting the second parameter to the fifth value smaller than the second value and greater than the fourth value.

The fourth value may be 1 and the fifth value may be 4.

The increasing, based on the back off time being not zero, the backoff time to twice the current value comprises setting the backoff time to a maximum backoff time based on the value obtained by increasing the backoff time to twice the current value being greater than a predetermined maximum backoff time.

### BRIEF DESCRIPTION OF THE DRAWINGS

FIG. 1 is a diagram illustrating the configuration of a typical access system of a 5G NR system.

FIG. 2 is a flowchart illustrating the downlink MCS selection method proposed in this specification; and

FIG. 3 is a flowchart illustrating a method for switching between SIMO and MIMO modes without using RI as proposed in this specification.

### DETAILED DESCRIPTION

Advantages and features of the present disclosure and methods of accomplishing the same may be understood more readily by reference to the detailed description of embodiments that will be made hereinafter with reference to the accompanying drawings. The present disclosure may, however, be embodied in many different forms and should not be construed as being limited to the exemplary embodiments set forth herein; rather, these exemplary embodiments are provided so that this disclosure will be thorough and complete and will fully convey the concept of the invention to those skilled in the art, and the present disclosure will only be defined by the appended claims. Throughout the specification, the same reference numerals refer to the same components.

When a component is described as “connected to” or “coupled to” another component, it can refer to a direct connection or coupling with the other component, or to a case where another component is interposed therebetween. Meanwhile, when a component is referred to as “directly connected to” or “directly coupled to” another component, it indicates that there is no other component interposed therebetween. The expression “and/or” is taken to include each of the mentioned items and any combination of one or more.

The terminology used in this specification is for the purpose of describing embodiments, and is not intended to limit the present disclosure. In this specification, the singular form includes the plural form unless otherwise specified in the phrase. The “comprises” and/or “comprising” used in the specification do not preclude the presence or addition of one or more other components, steps, operations, and/or devices mentioned.

Although the terms “first”, “second”, and the like are used for describing various components, these components are not confined by these terms. These terms are merely used for distinguishing one component from the other components.

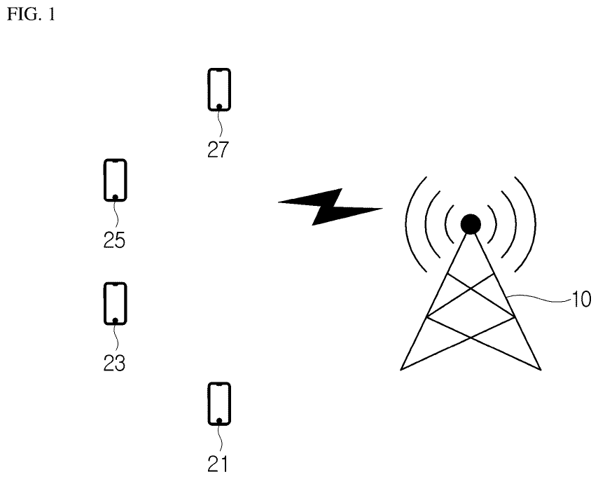

FIG. 1 is a diagram illustrating the configuration of a typical access system of a 5G NR system.

With reference to FIG. 1, a plurality of terminals 21, 23, 25, and 27 may be connected to a base station 10 for 5G NR communication.

The connected terminals 21, 23, 25, and 27 may determine the quality of the downlink (DL) channel based on the DL signal received from the base station 10 and transmit the corresponding channel quality indicator (CQI) information to the base station 10, and then, the base station 10 may determine the MCS for each terminal to use in data transmission based on the CQI information.

In cases where the mobility of the connected terminals 21, 23, 25, and 27 is very low, the quality of the downlink channel experienced by each terminal may not change significantly and may be similar. Therefore, the CQI information sent by each terminal to the base station may be of little use. Additionally, when there are a plurality of connected terminals 21, 23, 25, and 27, since all terminals need to transmit CQI information, a substantial portion of the uplink resources may be wasted transmitting this unnecessary CQI information, leading to a decrease in uplink throughput.

To address the aforementioned issues, this specification proposes a method for determining downlink MCS without using CQI information.

Table 1 shows an example of the parameters and MCSs used in the method proposed in this specification.

TABLE 1

| | | Target | | | | | | |
|---|---|---|---|---|---|---|---|---|
| | | Code | | | MIMO Mode | | | |
| MCS | Modulation | Rate x | | | switching | | MCS adjustment | |
| Index | Order | [1024] | Spectral Efficiency | | to | to | parameter | |
| I_{MCS} | Qₘ | R | SIMO | MIMO | SIMO | MIMO | TP inc. | NACK_INC |
| 0 | 2 | 120 | 0.2344 | 0.4688 | 1 | 0 | | 4 |
| 1 | 2 | 193 | 0.3770 | 0.7540 | 2 | 0 | 60.8% | 4 |
| 2 | 2 | 308 | 0.6016 | 1.2032 | 4 | 1 | 59.6% | 4 |
| 3 | 2 | 449 | 0.8770 | 1.7540 | 6 | 2 | 45.8% | 4 |
| 4 | 2 | 602 | 1.1758 | 2.3516 | 8 | 2 | 34.1% | 4 |
| 5 | 4 | 378 | 1.4766 | 2.9532 | 11 | 3 | 25.6% | 4 |
| 6 | 4 | 434 | 1.6953 | 3.3906 | 13 | 3 | 14.8% | 7 |
| 7 | 4 | 490 | 1.9141 | 3.8282 | 14 | 4 | 12.9% | 8 |
| 8 | 4 | 553 | 2.1602 | 4.3204 | 16 | 4 | 12.9% | 8 |
| 9 | 4 | 616 | 2.4063 | 4.8126 | 17 | 5 | 11.4% | 9 |
| 10 | 4 | 658 | 2.5703 | 5.1406 | 18 | 5 | 6.8% | 14 |
| 11 | 6 | 466 | 2.7305 | 5.4610 | 20 | 5 | 6.2% | 15 |
| 12 | 6 | 517 | 3.0293 | 6.0586 | 22 | 6 | 10.9% | 9 |
| 13 | 6 | 567 | 3.3223 | 6.6446 | 24 | 6 | 9.7% | 10 |
| 14 | 6 | 616 | 3.6094 | 7.2188 | 26 | 7 | 8.6% | 11 |
| 15 | 6 | 666 | 3.9023 | 7.8046 | 27 | 8 | 8.1% | 12 |
| 16 | 6 | 719 | 4.2129 | 8.4258 | 27 | 8 | 8.0% | 12 |
| 17 | 6 | 772 | 4.5234 | 9.0468 | 27 | 9 | 7.4% | 13 |
| 18 | 6 | 822 | 4.8164 | 9.6328 | 27 | 10 | 6.5% | 15 |
| 19 | 6 | 873 | 5.1152 | 10.2304 | 27 | 10 | 6.2% | 15 |
| 20 | 8 | 682.5 | 5.3320 | 10.6640 | 27 | 11 | 4.2% | 23 |
| 21 | 8 | 711 | 5.5547 | 11.1094 | 27 | 12 | 4.2% | 23 |
| 22 | 8 | 754 | 5.8906 | 11.7812 | 27 | 12 | 6.0% | 16 |
| 23 | 8 | 797 | 6.2266 | 12.4532 | 27 | 13 | 5.7% | 17 |
| 24 | 8 | 841 | 6.5703 | 13.1406 | 27 | 13 | 5.5% | 17 |
| 25 | 8 | 885 | 6.9141 | 13.8282 | 27 | 14 | 5.2% | 18 |
| 26 | 8 | 916.5 | 7.1602 | 14.3204 | 27 | 14 | 3.6% | 27 |
| 27 | 8 | 948 | 7.4063 | 14.8126 | 27 | 15 | 3.4% | 28 |

For 5G systems supporting 256-QAM, the standard document 3GPP TS 38.214 defines the MCS index, Modulation Order, and Target Code Rate as shown in Table 1, allowing for the calculation of spectral efficiency for single input multiple output (SIMO) and 2×2 multiple input multiple output (MIMO) transmissions.

The base station includes at least one processor, which, according to one embodiment, may be a general-purpose processor or a specialized system integrated circuit (IC) designed to perform the operations described below.

The base station may select one of the MCSs shown in Table 1 to transmit downlink data to the connected terminals.

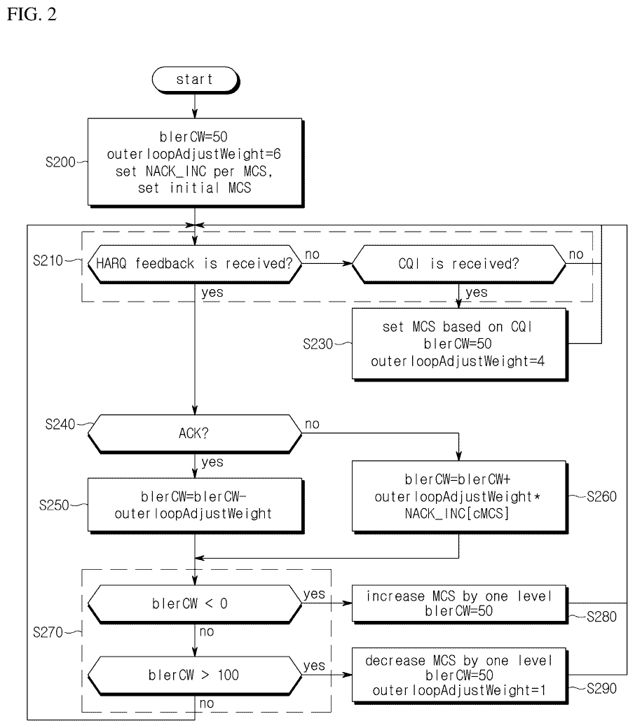

FIG. 2 is a flowchart illustrating the downlink MCS selection method proposed in this specification.

The flowchart depicted in FIG. 2 may be executed for a single terminal, and for multiple terminals, the method according to the flowchart in FIG. 2 may be performed independently in parallel or sequentially.

With reference to FIG. 2, to determine the downlink MCS for data transmission to the terminal, parameters for MCS determination may be set for each terminal in operation S200.

According to an embodiment, the parameters for MCS determination may include blerCW, outerloopAdjust Weight, and NACK_INC.

The outerloopAdjustWeight is a parameter used to determine the MCS change rate, which may be set to 6 during the initial terminal access as shown in FIG. 2, set to 4 once the MCS is selected based on CQI reception, and changed to 1 when the MCS is decreased according to the MCS selection method in FIG. 2. As a result, since the MCS may start at the lowest value during the initial access, in cases where CQI is not used, the outerloopAdjust Weight may be set to 6 to allow for rapid MCS changes, quickly increasing the MCS to an appropriate value, while when using CQI to select the MCS, the selected MCS may be considered to be somewhat near the appropriate value, allowing the outerloopAdjustWeight to be set to 4 to reduce the MCS change rate compared to the initial access. When the MCS decreases, it may be regarded as having reached an appropriate value, so the outerloopAdjust Weight may be set to 1 to further reduce the MCS change rate. According to an embodiment, once the outerloopAdjustWeight is set to 1, it may be maintained at that value until the terminal disconnects.

NACK_INC is an MCS adjustment parameter that may have different values for each MCS, with one example shown in Table 1.

In Table 1, the TP.inc column illustrates the difference in transmission rates according to the Target Code Rate. The TP.inc column shows the percentage increase in transmission rate of the corresponding MCS compared to the transmission rate of one step lower MCS. For example, in Table 1, when the MCS Index increases from 0 to 1, it indicates that the transmission rate increases by 60.8%.

An example of the NACK_INC values for each MCS is shown in the last column of Table 1. NACK_INC may have different values for each MCS and may indicate how much to increase the MCS adjustment parameter (blerCW) upon receiving a NACK. The NACK_INC value for each MCS may be determined by considering the change in transmission rate associated with increasing or decreasing the MCS (as reflected in the TP inc.column). For example, when lowering the MCS results in a relatively significant decrease in throughput, a higher target packet error rate (PER) may be set to maintain a higher MCS as much as possible, whereas when increasing the MCS does not lead to a substantial increase in throughput, a lower target PER may be set, ensuring that the MCS is increased only when the PER is sufficiently low.

The blerCW may be updated based on the reception of HARQ feedback indicating either an acknowledgment (ACK) for successful data reception or a negative acknowledgment (NACK) for failed data reception, and based on this result, the MCS may be adjusted.

According to an embodiment, blerCW may be initialized to a first value (e.g., 50) during the initial setup or when the MCS is changed, and as blerCW is updated, when it falls below a second value (e.g., 0), the MCS may be increased by one step, and when it exceeds a third value (e.g., 100), the MCS may be decreased by one step.

Accordingly, in operation S200, the base station 10 may set the parameter blerCW to 50, the parameter outerloopAdjust Weight to 6, the parameter NACK_INC as shown in Table 1 for each MCS, and the initial MCS to 0 for a connected terminal.

Subsequently, the base station 10 may perform data transmission based on the initial MCS and then wait to receive HARQ feedback or the initial CQI.

According to an embodiment, the method proposed in this specification suggests a way to determine the MCS for downlink data transmission to the terminal without requiring CQI, meaning that the operation of receiving CQI may not be utilized as an additional feature.

According to an embodiment, the base station 10 may set the MCS using only the initially received CQI and not use CQI thereafter. In this case, the terminal needs to transmit CQI only once, thereby reducing the waste of uplink resources.

According to and embodiment, the base station 10 may extend the time interval for the terminal to transmit CQI to several times longer than the previous value and reset the MCS to match the CQI each time CQI is received. Even in this case, the proportion of uplink resources used by the terminal to transmit CQI may be reduced compared to conventional methods, potentially increasing the transmission rate of uplink resources.

To support the various embodiments described above, in operation S210, the base station 10 may perform an operation to determine whether a HARQ feedback or CQI has been received.

Upon determining in operation S210 that CQI has been received, the base station 10 may initialize the parameter blerCW to 50 in operation S230, set the parameter outerloopAdjust Weight to a second value, and set the MCS based on the received CQI.

TABLE 2

| CQI | | | | appropriate | initial |
|---|---|---|---|---|---|
| index | modulation | code rate × 1024 | efficiency | MCS | MCS |
| 0 | out of range | | | 1 | 1 |
| 1 | QPSK | 78 | 0.1523 | 1 | 1 |
| 2 | QPSK | 193 | 0.377 | 1 | 1 |
| 3 | QPSK | 449 | 0.877 | 3 | 2 |
| 4 | 16QAM | 378 | 1.4766 | 5 | 4 |
| 5 | 16QAM | 490 | 1.9141 | 7 | 6 |
| 6 | 16QAM | 616 | 2.4063 | 9 | 8 |
| 7 | 64QAM | 466 | 2.7305 | 11 | 9 |
| 8 | 64QAM | 567 | 3.3223 | 13 | 11 |
| 9 | 64QAM | 666 | 3.9023 | 15 | 13 |
| 10 | 64QAM | 772 | 4.5234 | 17 | 15 |
| 11 | 64QAM | 873 | 5.1152 | 19 | 17 |
| 12 | 256QAM | 711 | 5.5547 | 21 | 18 |
| 13 | 256QAM | 797 | 6.2266 | 23 | 20 |
| 14 | 256QAM | 885 | 6.9141 | 25 | 22 |
| 15 | 256QAM | 948 | 7.4063 | 27 | 24 |

According to an embodiment, the base station 10 may set the MCS based on the received CQI according to Table 2 above. In this case, to account for situations where the CQI received from the terminal overestimates the actual downlink channel conditions, the initial MCS may be conservatively set to a value lower than the appropriate MCS. For example, based on Table 2, upon receiving a CQI value (CQI index) of 6 from the terminal, the base station 10 may set the initial MCS to 8. According to an embodiment, upon receiving a CQI value (CQI index) of 6 from the terminal, the base station 10 may set the MCS to 9, which is the appropriate MCS.

According to an embodiment, based on the received CQI, the base station 10 may continue using the currently utilized MCS when the MCS is less than the maximum allowed MCS for that CQI, as shown in Table 3 below; however, when the currently used MCS exceeds the maximum allowed MCS for that CQI, the MCS may be changed to the maximum allowed MCS for that CQI.

TABLE 3

| CQI | maximum allowed |
|---|---|
| index | MCS |
| 0 | 0 |
| 1 | 1 |
| 2 | 3 |
| 3 | 4 |
| 4 | 8 |
| 5 | 10 |
| 6 | 12 |
| 7 | 14 |
| 8 | 16 |
| 9 | 17 |
| 10 | 19 |
| 11 | 22 |
| 12 | 24 |
| 13 | 25 |

Upon receiving CQI from the terminal while determining the MCS for use in transmitting data to the terminal based on HARQ feedback, the base station 10 may compare the current MCS (cMCS) with the maximum allowed MCS corresponding to the received CQI, continuing to use the current MCS when the current MCS is less than or equal to the maximum allowed MCS, and changing the MCS for transmitting data to the terminal to the maximum allowed MCS when the current MCS exceeds the maximum allowed MCS. This indicates that adjusting the MCS based on HARQ feedback may result in slower responses to rapid channel changes, and to compensate for this, a maximum limit on MCS based on the CQI report value may be established to prevent the MCS from remaining at too high a value when the CQI value drops sharply. For example, when the currently used MCS (cMCS) is 27 and the received CQI value is 13, then according to Table 3, the maximum allowed MCS corresponding to the received CQI value may be 25. In this case, the currently used MCS (cMCS) may be changed to the maximum allowed MCS of 25 based on the CQI value.

Thus, setting the MCS based on CQI by the base station 10 may somewhat reflect the downlink channel conditions. Therefore, to reduce the MCS change rate, the base station 10 may set the parameter outerloopAdjustWeight, which controls the speed of changing the MCS adjustment parameter, to a second value.

As described above, the base station 10 may additionally perform the operation of resetting the MCS based on CQI. That is, the base station 10 may not perform the CQI-based MCS reset operation at all or perform the operation upon the initial reception of CQI or each time CQI is received.

Upon receiving HARQ feedback in operation S210, the base station 10 may determine in operation S240 whether the received HARQ feedback indicates successful data reception (ACK) or data reception failure (NACK).

When the HARQ feedback is an ACK, the base station 10 may decrease blerCW in operation S250 using the equation blerCW=blerCW-outerloopAdjust Weight; when the HARQ feedback is a NACK, the base station 10 may increase blerCW in operation S260 using the equation blerCW=blerCW+outerloopAdjust Weight*NACK_INC[cMCS]. Here, cMCS refers to the currently set MCS, and NACK_INC[cMCS] may represent the NACK_INC value for the MCS Index of cMCS as shown in Table 1.

In operation S270, the base station 10 may evaluate the parameter blerCW for downlink MCS changes. When the parameter blerCW is determined to be less than 0, the base station may increase the MCS by one level and initialize the parameter blerCW to 50 in operation S280. When the parameter blerCW is determined to be greater than 100, the base station 10 may decrease the MCS by one level, initialize the parameter blerCW to 50, and set the parameter outerloopAdjustWeight to 1 in operation S290.

The base station 10 may determine the MCS to be used for downlink data transmission for each terminal according to the flowchart shown in FIG. 2.

In the case where the base station 10 operates in time division duplex (TDD) mode, there may be special subframe (SP) slots that coexist with downlink (DL), TDD gap, and uplink (UL) intervals during the time period when transitioning from downlink to uplink within a frame. In the downlink (DL) slots, all symbols are used for downlink data transmission; however, in the SP slots, only some symbols are used for downlink data transmission, which may lead to degraded packet reception performance. To compensate for this, the MCS for SP slots may be set slightly lower than the MCS determined for the downlink (DL) slots according to FIG. 2. For example, when the MCS determined for downlink is between 0 and 10, the MCS for the SP slots may be maintained at the same level. Furthermore, when the downlink MCS is between 11 and 24, the MCS for the SP slots may be set to one level lower. Additionally, when the downlink MCS is between 25 and 27, the MCS for the SP slots may be set to two levels lower.

5G NR systems support downlink multiple input multiple output (MIMO). The terminal starts with single input multiple output (SIMO) mode and can switch to MIMO mode under certain conditions. While there are following two methods for selecting MIMO mode, other approaches may also be used. Although it is assumed in the following description that the maximum number of MIMO layers is 2, similar principles may apply in cases with more than two layers.

According to an embodiment, the base station may select the MIMO mode based on the rank indication (RI) reported by the terminal. RI is a metric that indicates how well MIMO is functioning, and a higher RI means that the signals received by the two antennas of the terminal are uncorrelated and can be distinguished from each other, resulting in better performance. Accordingly, when the RI transmitted by the terminal is equal to or greater than a predetermined threshold, the base station 10 may switch from SIMO mode to MIMO mode. The base station 10 may also switch from MIMO mode to SIMO mode when the RI transmitted by the terminal is equal to or less than a predetermined threshold.

When the base station 10 changes the downlink mode for data transmission between SIMO and MIMO, the MCS used for data transmission may also be adjusted accordingly. An example of this is illustrated in the “MIMO mode change” column of Table 1. For example, when the currently set MCS is 10 in SIMO mode, referring to the “to MIMO” column in Table 1 indicates that the MCS can be changed to 5 upon switching to MIMO mode. Similarly, when the currently set MCS is 10 in MIMO mode, referring to the “to SIMO” column in Table 1 indicates that the MCS can be changed to 18 when switching to SIMO mode.

According to an embodiment, the base station 10 may switch between SIMO and MIMO modes without using RI. In this case, when the channel characteristics are unsuitable for MIMO mode, continuous attempts to switch to MIMO mode may lead to performance degradation. Therefore, in cases where the terminal enters MIMO mode without relying on RI and fails to maintain or increase the MCS due to an increase in PER, leading to a fallback to SIMO mode, a backoff algorithm can be implemented to prevent re-entry into MIMO mode for a predetermined period.

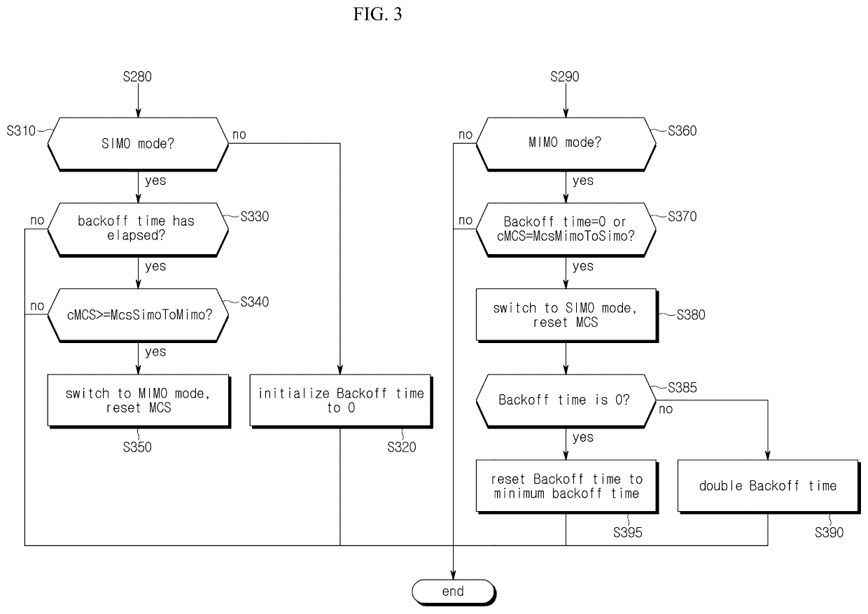

FIG. 3 is a flowchart illustrating a method for switching between SIMO and MIMO modes without using RI as proposed in this specification.

With reference to FIG. 3, the base station 10 may proceed with the operations depicted in FIG. 3 after performing either operation S280 or operation S290 in FIG. 2. Upon the increase of MCS by one level in operation S280, the base station 10 may determine whether to change the downlink data transmission mode from SIMO mode to MIMO mode according to the flowchart in FIG. 3. Upon the decrease of MCS by one level in operation S290, the base station 10 may determine whether to change the downlink data transmission mode from MIMO mode to SIMO mode according to the flowchart in FIG. 3.

With reference to FIG. 3, when the MCS increases by one level, the base station 10 may determine in operation S310 whether the current mode is SIMO mode or MIMO mode. When the current mode is MIMO mode, the backoff time may be initialized to 0. The backoff time is a parameter used to prohibit entry into MIMO mode for a predetermined period; when the backoff is 0, the transition from SIMO mode to MIMO mode may occur immediately upon conditions being met. The backoff method using the backoff time will be explained in more detail later.

When the current mode is SIMO mode, the base station 10 may determine in operation S330 whether the backoff time has elapsed after switching to SIMO mode. When the backoff time has not elapsed, the switching to MIMO mode may be deferred.

When the backoff time has elapsed, the base station 10 may determine in operation S340 whether the MCS (cMCS) currently used for data transmission is equal to or greater than a preconfigured parameter (McsSimoToMimo) for transitioning from SIMO mode to MIMO mode. Upon determining in operation S340 that the MCS (cMCS) currently used for data transmission is less than the preconfigured parameter (McsSimoToMimo), the base station 10 may not switch to MIMO mode, but when the MCS is greater than or equal to the preconfigured parameter, the base station may switch the data transmission mode to MIMO mode in operation S350.

After switching from SIMO to MIMO mode, the base station 10 may refer to Table 1 to adjust the MCS used for data transmission as described above. For example, when the MCS used in SIMO mode was 12, switching to MIMO mode may occur with the change of the MCS to 6 by referring to the “MCS Index” and “to MIMO” columns in Table 1.

With reference to FIG. 3, when the MCS decreases by one level, the base station 10 may determine in operation S360 whether the current mode is SIMO mode or MIMO mode. When the current mode is SIMO mode, the base station 10 may maintain SIMO mode without any additional operations.

When the current mode is MIMO mode, the base station 10 may determine in operation S370 whether the backoff time is zero or whether the MCS (cMCS) currently used for data transmission is less than or equal to a preconfigured parameter (McsMimoToSimo) for transitioning from MIMO mode to SIMO mode. When the backoff time is not zero or the MCS (cMCS) currently used for data transmission is less than or equal to a preconfigured parameter (McsMimoToSimo) for transitioning from MIMO mode to SIMO mode, the base station 10 may switch the data transmission mode to SIMO mode in operation S380

After switching from MIMO to SIMO mode, the base station 10 may refer to Table 1 to adjust the MCS used for data transmission as described above. For example, when the MCS used in MIMO mode was 12, the MCS may be changed to 22 upon transitioning to SIMO mode by referring to the “MCS Index” and “to SIMO” columns in Table 1.

Next, the base station 10 may determine in operation S385 whether the currently set backoff time is zero.

When it is determined in operation S385 that the backoff time is not zero, the base station 10 may double the backoff time in operation S390.

When it is determined in operation S385 that the backoff time is zero, the base station 10 may reset the backoff time to a predetermined minimum backoff time in operation S395.

As shown in FIG. 3, when the MCS increases by even one level after switching from SIMO mode to MIMO mode, the backoff time may be reset to zero in operation S320; subsequently, when the mode is switched back from MIMO mode to SIMO mode, the backoff time may be set to the minimum backoff time in operation S395. Meanwhile, when the mode is switched back to SIMO mode immediately after changing from SIMO mode to MIMO mode without an increase in MCS, the backoff time may remain at its previous value and then be doubled in operation S390. That is, in cases where there is a transition from SIMO mode to MIMO mode and then back to SIMO mode, the backoff time may be exponentially increased, extending the duration of remaining in SIMO mode. This is intended to prevent performance degradation due to continuous attempts to switch to MIMO mode when channel conditions are unsuitable for MIMO. According to an embodiment, the backoff time may increase exponentially but cannot be set to exceed a predetermined maximum backoff time (e.g., 16,000 ticks).

With the above-described operations, the base station 10 may determine the MCS to be used for data transmission to the terminal without relying on CQI reports from the terminal or with minimal CQI reports. This helps conserve uplink resources used for CQI reporting, thereby improving uplink throughput and efficiency.

The embodiments of the present disclosure are advantageous in terms of improving uplink performance by assigning an appropriate MCS to the terminal without relying on CQI, which consumes uplink resources.

What is claimed is:

1. A base station of a 5^{th} generation new radio (5G NR) system comprising at least one processor configured to:
transmit data based on a determined modulation and coding scheme (MCS) for a terminal;
receive hybrid automatic repeat request (HARQ) feedback indicating whether the transmitted data was successfully received; and
determine a transmission MCS being an MCS to be used for transmitting data to the terminal based on the received HARQ feedback,
wherein the at least one processor further configured to:
set a first parameter to a first value, a second parameter to a second value, and a third parameter to a different third value for each MCS;
determine the transmission MCS for the initial data transmission to the terminal;
update the first parameter based on the HARQ feedback and the second and third parameters;
determine whether to increase or decrease the transmission MCS by one level or maintain the transmission MCS based on the updated first parameter.

2. The base station of claim 1, wherein, when the transmission MCS is increased by one level, the at least one processor is further configured to:
determine whether a transmission mode is single input multiple output (SIMO) mode or multiple input multiple output (MIMO) mode;
set, based on the transmission mode being MIMO mode, a backoff time to zero;
change, based on the transmission mode being SIMO mode, the transmission mode to MIMO mode and redetermine the transmission MCS based on a predetermined conversion table when the transmission mode have been in the SIMO mode over the backoff time and the transmission MCS is greater than or equal to a predetermined fourth parameter.

3. The base station of claim 2, wherein, when the transmission MCS is decreased by one level, the at least one processor is further configured to:
determine whether the transmission mode is SIMO mode or MIMO mode;
based on the transmission mode being MIMO mode,
change the transmission mode to SIMO mode and redetermine the transmission MCS based on a predetermined conversion table when the backoff time is not zero or the transmission MCS is less than or equal to a predetermined fifth parameter; and
set, based on the back off time being zero, the backoff time to a predetermined minimum backoff time and increase, based on the back off time being not zero, the backoff time to twice the current value.

4. The base station of claim 1, wherein the at least one processor is further configured to:
update, based on the HARQ feedback indicating successful data reception (ACK), the first parameter by subtracting the second parameter from the first parameter, and
update, based on the HARQ feedback indicating unsuccessful data reception (NACK), the first parameter by adding to the first parameter the value obtained by multiplying the third parameter corresponding to the current transmission MCS by the second parameter.

5. The base station of claim 4, wherein the first value is 50, the second value is 6, and the at least one processor is further configured to:
increase the transmission MCS by one level and reset the first parameter to the first value based on the updated first parameter being less than 0;
decrease the transmission MCS by one level, reset the first parameter to the second value and set the second parameter to a fourth value smaller than the second value based on the updated first parameter being greater than 100; and
maintain the transmission MCS based on the updated first parameter being greater than or equal to 0 and less than or equal to 100.

6. The base station of claim 5, wherein the at least one processor is further configured to:
upon receiving a channel quality indicator (CQI) from the terminal, determine the transmission MCS based on the CQI, reset the first parameter to the first value and set the second parameter to a fifth value smaller than the second value and greater than the fourth value.

7. The base station of claim 6, wherein the fourth value is 1 and the fifth value is 4.

8. The base station of claim 6, wherein the at least one processor is further configured to:
only upon receiving the channel quality indicator (CQI) for the first time from the terminal, determine the transmission MCS based on the CQI received for the first time, reset the first parameter to the first value and set the second parameter to the fifth value smaller than the second value and greater than the fourth value.

9. The base station of claim 8, wherein the fourth value is 1 and the fifth value is 4.

10. The base station of claim 3, wherein the at least one processor is further configured to:
set the backoff time to a maximum backoff time based on the value obtained by increasing the backoff time to twice the current value being greater than a predetermined maximum backoff time.

11. A method for determining a downlink modulation and coding scheme (MCS) of a base station, the method comprising:
transmitting data based on a determined modulation and coding scheme (MCS) for the terminal;
receiving hybrid automatic repeat request (HARQ) feedback indicating whether the transmitted data was successfully received; and
determining a transmission MCS being an MCS (to be used for transmitting data to the terminal based on the received HARQ feedback,
wherein the determining of the transmission MCS comprises:
setting a first parameter to a first value, a second parameter to a second value, and a third parameter to a different third value for each MCS;
determining the transmission MCS for the initial data transmission to the terminal;
updating the first parameter based on the HARQ feedback and the second and third parameters; and
determining whether to increase or decrease the transmission MCS by one level or maintain the transmission MCS based on the updated first parameter.

12. The method of claim 11, wherein the determining whether to increase or decrease the transmission MCS by one level or maintain the transmission MCS based on the updated first parameter comprises, when the transmission MCS is increased by one level:
determining whether a transmission mode is single input multiple output (SIMO) mode or multiple input multiple output (MIMO) mode;
setting, based on the transmission mode being MIMO mode, a backoff time to zero;
changing, based on the transmission mode being SIMO mode, the transmission mode to MIMO mode and redetermining the transmission MCS based on a predetermined conversion table when the transmission mode have been in the SIMO mode over the backoff time and the transmission MCS is greater than or equal to a predetermined fourth parameter.

13. The method of claim 12, wherein the determining whether to increase or decrease the transmission MCS by one level or maintain the transmission MCS based on the updated first parameter further comprises, when the transmission MCS is decreased by one level:
determining, whether the transmission mode is SIMO mode or MIMO mode;
based on the transmission mode being MIMO mode,
changing the transmission mode to SIMO mode and redetermining the transmission MCS based on a predetermined conversion table when the backoff time is not zero or the transmission MCS is less than or equal to a predetermined fifth parameter and
setting, based on the back off time being zero, the backoff time to a predetermined minimum backoff time and increasing, based on the back off time being not zero, the backoff time to twice the current value.

14. The method of claim 11, wherein the updating of the first parameter based on the HARQ feedback and the second and third parameters comprises:
updating, based on the HARQ feedback indicating successful data reception (ACK), the first parameter by subtracting the second parameter from the first parameter, and
updating, based on the HARQ feedback indicating unsuccessful data reception (NACK), the first parameter by adding the value obtained by multiplying the third parameter corresponding to the current transmission MCS by the second parameter.

15. The method of claim 14, wherein the first value is 50, the second value is 6, and the determining of whether to increase or decrease the transmission MCS by one level or maintain the transmission MCS based on the updated first parameter comprises:
increasing the transmission MCS by one level and reset the first parameter to the first value based on the updated first parameter being less than 0;
decreasing the transmission MCS by one level, reset the first parameter to the second value and set the second parameter to a fourth value smaller than the second value based on the updated first parameter being greater than 100; and
maintaining the transmission MCS based on the updated first parameter being greater than or equal to 0 and less than or equal to 100.

16. The method of claim 15, further comprising:
receiving a channel quality indicator (CQI) from the terminal; and
determining the transmission MCS based on the CQI, resetting the first parameter to the first value, and setting the second parameter to a fifth value less than the second value and greater than the fourth value.

17. The method of claim 16, wherein the fourth value is 1 and the fifth value is 4.

18. The method of claim 16, wherein further comprising:
when CQI is received for the first time from the terminal, determining the transmission MCS based on the CQI received for the first time, resetting the first parameter to the first value and setting the second parameter to the fifth value smaller than the second value and greater than the fourth value.

19. The method of claim 18, wherein the fourth value is 1 and the fifth value is 4.

20. The method of claim 13, wherein the increasing, based on the back off time being not zero, the backoff time to twice the current value comprises setting the backoff time to a maximum backoff time based on the value obtained by increasing the backoff time to twice the current value being greater than a predetermined maximum backoff time.
